(19) United States
(12) Patent Application Publication
(10) Pub. No.: US 2011/0085625 A1
(43) Pub. Date: Apr. 14, 2011

(54) RECEIVER AND SEMICONDUCTOR DEVICE

(75) Inventors: Tatsuya URAKAWA, Kanagawa (JP); Noriaki Matsuno, Kanagawa (JP)

(73) Assignee: Renesas Electronics Corporation, Kanagawa (JP)

(21) Appl. No.: 12/902,679

(22) Filed: Oct. 12, 2010

(30) Foreign Application Priority Data
Oct. 14, 2009 (JP) 2009-237074

(51) Int. Cl. H04L 27/08; H04B 1/06

(52) U.S. Cl. 375/345; 455/234.1

(57) ABSTRACT

A receiver includes an automatic gain control (AGC) loop and a filter group that is arranged downstream of the AGC loop. The filter group includes an active filter. The receiver further includes a power difference detector and a switch circuit. The power difference detector detects a power difference between intermediate and output nodes of the filter group to detect presence of an interference wave that is different from a desired wave and that has a frequency near that of the desired wave. The switch circuit switches an operation to suppress a convergence power of the AGC loop when the power difference detector detects the interference wave.

### REFERENCE TO RELATED APPLICATION

This application is based upon and claims the benefit of the priority of Japanese patent application No. 2009-237074, filed on Oct. 14, 2009, the disclosure of which is incorporated herein in its entirety by reference thereto.

### TECHNICAL FIELD

The present invention relates to a receiver and a semiconductor device including a semiconductor substrate on which a receiver is formed. In particular, the present invention relates to a receiver including an automatic gain control (AGC) loop and an active filter.

### BACKGROUND

Receivers of a super-heterodyne system are widely used. Based on this system, a received signal is converted to an intermediate frequency (hereinafter referred to as IF) signal, and signal processing is carried out on the received signal converted to the IF signal. For this conversion from a received signal to an intermediate frequency, a mixer circuit is used, and the mixer circuit receives a signal outputted from a local oscillator (hereinafter referred to as LO) and the received signal. A frequency difference between these signals is used as a frequency of the intermediate frequency signal (IF signal: mixer circuit output signal).

Assuming that the intermediate frequency signal has a constant frequency, by changing an oscillation frequency of the local oscillator, the receivable signal frequency is changed. Namely, the target signal frequency can be controlled by the oscillation frequency of the local oscillator. Generally, a signal inputted to a receiver includes a target frequency signal (desired wave) and unnecessary frequency signals (interference waves). In order to output only the desired wave as the intermediate frequency signal among the above waves, the oscillation frequency of the local oscillator needs to be adjusted so that the difference between a frequency of the desired wave and the oscillation frequency of the local oscillator is used as the frequency of the intermediate frequency signal. In addition, a filter circuit that reduces the interference waves of the intermediate frequency signal included in an output signal from the mixer circuit and that extracts only the desired wave is necessary.

Capability of a receiver to suppress the interference wave is represented as an interference wave suppression ratio, and an excellent receiver has a higher suppression ratio. Generally, the smaller the frequency difference between a desired wave and an interference wave, the lower the interference wave suppression ratio of the receiver. In view of this, normally, communication system standards define a relatively smaller value for the interference wave suppression ratio when the frequency difference is small and a larger value when the frequency difference is large. FIG. 2 illustrates standards of such interference wave suppression ratio used in various types of TV broadcasting. In FIG. 2, the solid line represents Advanced Television Systems Committee (ATSC) standards adopted in the U.S. and other countries, and the dashed line represents Digital Video Broadcasting-Terrestrial (DVB-T) and Nordig standards mainly adopted in Europe.

FIG. 3 is a block diagram of a conventional receiver. A received signal inputted to an input terminal IN is amplified by an AGC loop 110 to a certain power level and is inputted to a mixer circuit MIXER. In the mixer circuit MIXER, the output signal from the AGC loop 110 is synthesized with an oscillation frequency from a local oscillator LO and is converted to an intermediate frequency signal. Subsequently, a high frequency, which is an interference wave that interferes with a target desired wave, is removed from the intermediate frequency signal by an intermediate frequency low pass filter IFLPF, and a desired frequency signal is outputted from an output terminal OUT.

The AGC loop 110 includes: a radio frequency variable gain amplifier RFVGA amplifying a received signal inputted to the input terminal IN; a power detector DET detecting an output power from the radio frequency variable gain amplifier RFVGA and outputting the output power as a voltage signal; and a differential amplifier DIFFAMP controlling a gain of the radio frequency variable gain amplifier RFVGA based on a voltage difference between a reference voltage Vref and an output voltage from the power detector DET. The AGC loop as a whole automatically controls the gain of the radio frequency variable gain amplifier RFVGA based on the level of a received signal and operates so that the output power from the AGC loop is converged to a certain level.

Originally, AGC needs to be performed only on the desired wave. However, there are cases where sensitivity of AGC is excessively suppressed by presence of an interference wave and reception of a desired wave is suppressed. In response to this problem, Patent Document 1 discloses an FM receiver including a band detection circuit that detects a frequency difference between an output from an FM detector and an IF frequency from a mixer. According to this document, when the band detection circuit detects an interference wave near the frequency band of a target desired wave, the band detection circuit decreases sensitivity of an AGC amplifier arranged in a feedback system to a minimum level, so that a gain of an RF amplifier is increased. According to Patent Document 1, the AGC amplifier is arranged in the feedback system, and level detection is carried out based on the output from the AGC amplifier. Thus, when sensitivity of the AGC amplifier is brought to be a minimum level, the gain of the output with respect to the input in the AGC loop, that is, a convergence power of the AGC loop, is increased to be a maximum level.

Patent Document 2 discloses an AGC circuit for an FM receiver. Based on this AGC circuit, two AGC voltages are generated, one from an input signal to a mixing circuit (mixer) and the other from an output signal from a filter, and the higher voltage of the two voltages is used for AGC. Different AGC voltages are used depending on whether an interference wave is present within a filter band or not.

Patent Document 3 discloses a filter circuit that uses an output and an intermediate output thereof to detect levels of an overall signal power, a desired wave, and an interference wave inputted to the filter circuit. Based on the detection results, the filter circuit controls the order, circuit configuration, and internal parameters thereof.

Patent Document 1: Japanese Patent Kokai Publication No. JP-A-8-111648
Patent Document 2: Japanese Patent Kokai Publication No. JP-P2003-218711A, which corresponds to US Patent Application Publication No. US2003/0139157A1.
Patent Document 3: Japanese Patent Kokai Publication No. JP-P2001-16121A

### SUMMARY

The above Patent Documents are incorporated herein by reference thereto.

The following analyses are given by the present invention. In order to obtain only a desired wave frequency from a received frequency and remove an interference wave frequency near the desired wave frequency, the number of stages of a filter circuit needs to be increased and steep attenuation characteristics need to be provided with the filter circuit. However, if steep attenuation characteristics are provided with the filter circuit, near a cutoff frequency, even when a downstream amplifier in the filter circuit is not saturated, an upstream amplifier in the filter circuit is saturated. Consequently, the overall input referred saturation power characteristics of the filter circuit are deteriorated.

If such frequency band in which the input referred saturation power characteristics are deteriorated overlaps with an interference wave band near a desired wave, the interference wave suppression ratio is deteriorated.

According to a first aspect of the present invention, there is provided a receiver comprising an automatic gain control (AGC) loop, and a filter group that is arranged downstream of the AGC loop and that includes an active filter. The receiver further comprising a power difference detector and a switch circuit. The power difference detector detects a power difference between intermediate and output nodes of the filter group to detect presence of an interference wave. The interference wave is different from a desired wave and the interference wave has a frequency near that of the desired wave. The switch circuit switches an operation to suppress a convergence power of the AGC loop when the power difference detector detects the interference wave.

According to a second aspect of the present invention, there is provided a semiconductor device comprising a semiconductor substrate and the receiver fabricated on the semiconductor substrate.

The meritorious effects of the present invention are summarized as follows.

According to the present invention, when presence of an interference wave having a frequency near that of a desired wave is detected, a convergence power of the AGC loop is suppressed. Thus, saturation of the active filter can be prevented. When presence of an interference wave having a frequency away from that of a desired wave is detected, a convergence power of the AGC loop can be increased within a range in which the active filter is not saturated, and the S/N ratio of the output of the active filter can be improved. Namely, a high interference wave suppression ratio can be obtained constantly regardless of the interference wave frequency.

### BRIEF DESCRIPTION OF THE DRAWINGS

FIG. 1 is a block diagram of an overall configuration of a receiver according to an example of the present invention.

FIG. 2 illustrates interference wave suppression ratio standards used in various types of TV broadcasting.

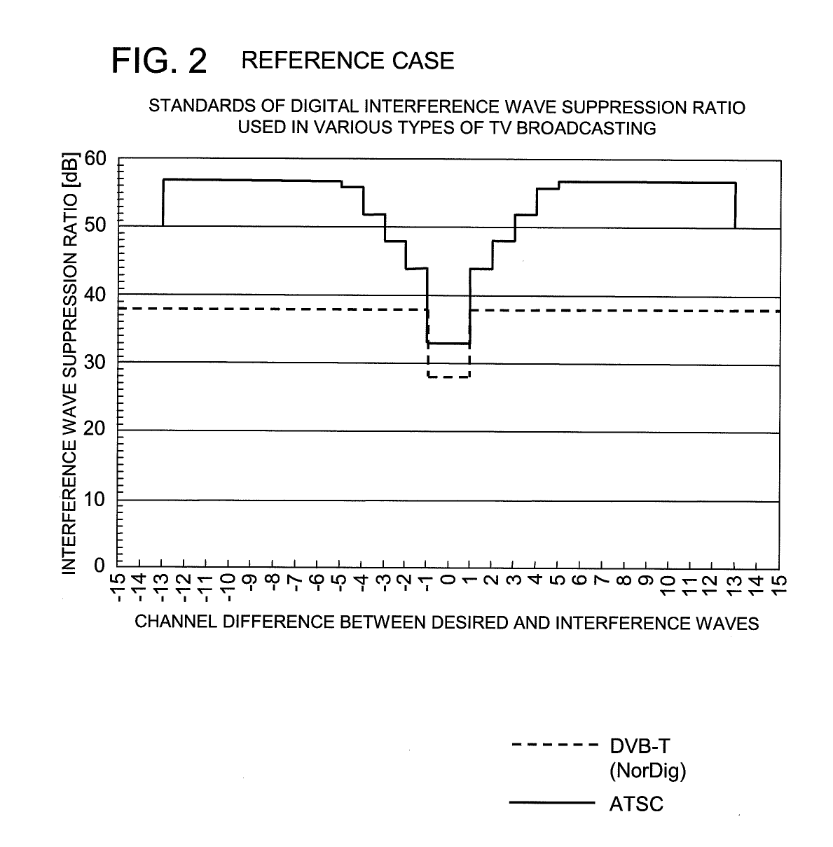

FIG. 3 is a block diagram of a conventional receiver.

FIG. 4 illustrates attenuation characteristics and input referred saturation power characteristics of an intermediate frequency low pass filter.

FIG. 5 illustrates a relationship between an AGC convergence power and an interference wave suppression ratio.

FIG. 6 illustrates a relationship between the attenuation characteristics, input referred saturation power characteristics, and received frequencies of the intermediate frequency low pass filter.

FIG. 7 illustrates a relationship between the AGC convergence power and the interference wave suppression ratio according to a conventional technique.

FIG. 8 is a block diagram of a configuration example of an intermediate frequency low pass filter.

FIGS. 9A to 9C illustrate signal frequency and power levels at input, intermediate, and output nodes of the intermediate frequency low pass filter according to an example.

FIG. 10 illustrates a relationship between an interference wave and the interference wave suppression ratio according to an example.

FIG. 11 is a block diagram of an overall configuration of a receiver according to another example.

FIG. 12 is a block diagram of an overall configuration of a receiver according to still another example.

### PREFERRED MODES

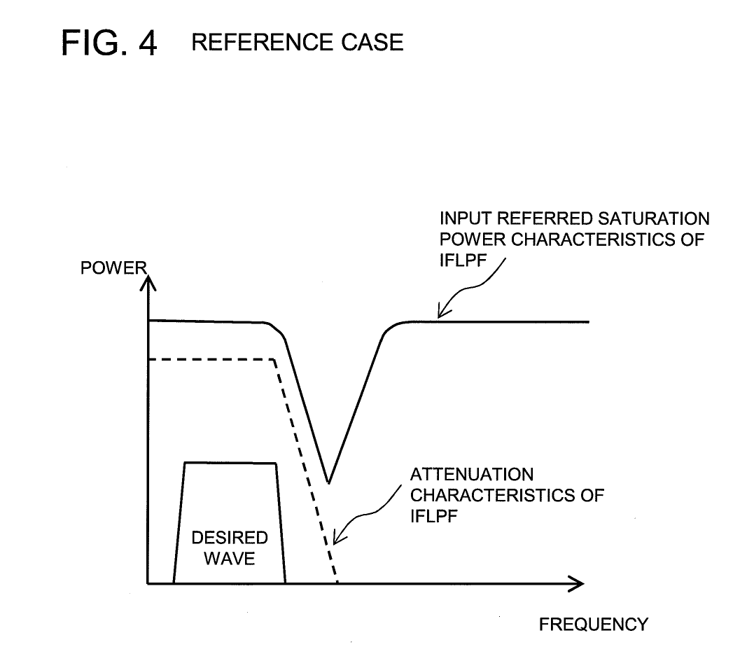

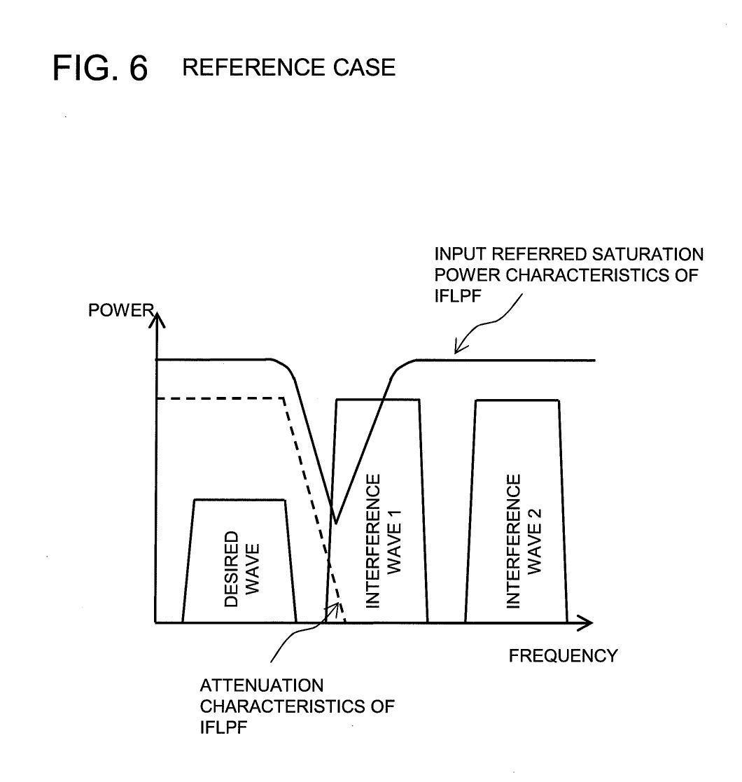

Prior to description of embodiments of the present invention, problems associated with the conventional techniques described in the above “SUMMARY”, that is, deterioration of the input referred saturation power characteristics and the interference wave suppression ratio, will be hereinafter described in more detail with reference to the drawings. FIG. 4 illustrates attenuation characteristics and input referred saturation power characteristics of an intermediate frequency low pass filter (IFLPF). Further, FIG. 6 illustrates frequencies of a desired wave and interference waves 1 and 2. The interference wave 1 has a frequency near the frequency of the desired wave and the interference wave 2 has a frequency away from the frequency of the desired wave. Hereinafter, for ease of description, an interference wave having a frequency near the frequency of a desired wave will be referred to as interference wave 1, and an interference wave having a frequency away from the frequency of a desired wave will be referred to as interference wave 2. As illustrated in FIG. 6, to cut off the interference wave 1 near the desired wave without attenuating the desired wave, it is necessary that the filter circuit have steep attenuation characteristics. However, to allow the active filter to have steep attenuation characteristics, the order of the filter circuit needs to be increased. Namely, resistors, capacitors, and amplifiers forming the filter circuit need to be formed in multiple stages, to increase the number of stages of the active filter.

In addition, active elements are used for amplifiers of the active filter. Thus, the active filter can function as a filter only within a power range in which the active elements are not saturated. The higher the input power that does not cause saturation becomes, the higher the output S/N ratio can be maintained, and these filters are considered high-performance filters. The above characteristics are referred to as input referred saturation power characteristics and used as a filter performance index.

However, if the number of stages of the active filter is increased to obtain steep attenuation characteristics, at internal nodes of the filter, a higher amplification factor is exhibited near a cutoff frequency. Thus, the input referred saturation power characteristics are more deteriorated at the cutoff frequency than at other frequencies where a lower amplification factor is exhibited. This is illustrated in FIGS. 4 and 6 as the input referred saturation power characteristics of the intermediate frequency low pass filter IFLPF. This problem is inherent in active filters, and the steeper the filter attenuation characteristics become, the more deteriorated the input referred saturation power characteristics tend to be. Namely, if an input signal near the cutoff frequency is given, even when a downstream amplifier in the filter circuit is not saturated, an upstream amplifier in the filter circuit is saturated, and as a result, the overall input referred saturation power characteristics of the filter circuit are deteriorated.

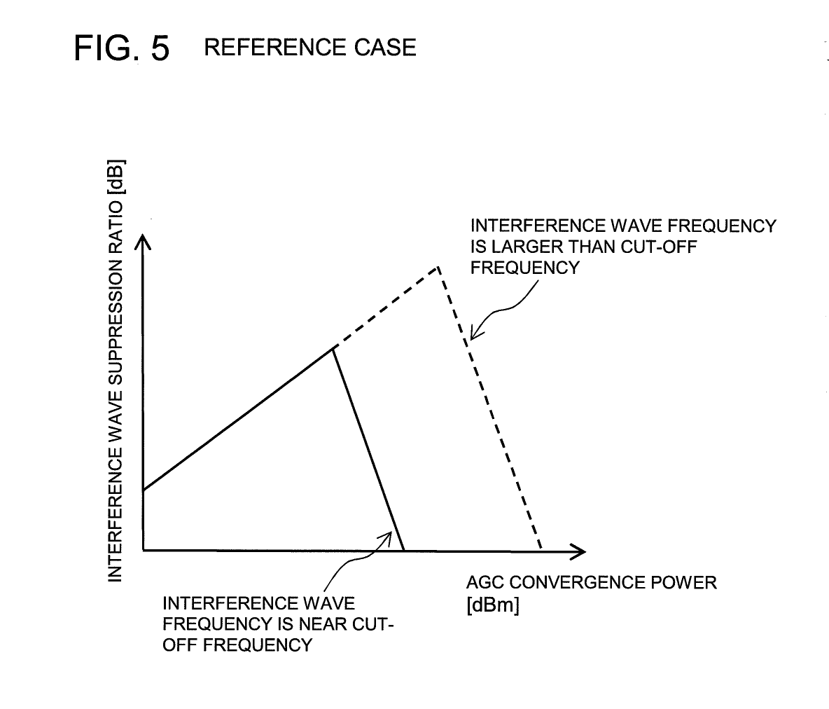

FIG. 5 illustrates a relationship between an AGC convergence power and the interference wave suppression ratio. If the AGC convergence power, which is a power outputted from the AGC loop, is increased, the power inputted to the intermediate frequency low pass filter IFLPF via the mixer circuit MIXER is increased. If the input power to the intermediate frequency low pass filter IFLPF is increased, a high S/N ratio of the output signal from the intermediate frequency low pass filter IFLPF can be maintained. As a result, the interference wave suppression ratio can be improved. However, if the input power to the intermediate frequency low pass filter IFLPF is increased excessively, the input referred saturation power characteristics are exceeded. Thus, since the intermediate frequency low pass filter IFLPF is saturated, the interference wave suppression ratio is deteriorated significantly.

As described above, if an interference wave frequency is higher than the cutoff frequency of the intermediate frequency low pass filter IFLPF (the interference wave 2 in FIG. 6), the AGC convergence power can be increased up to a level that corresponds to where the input referred saturation power characteristics of the intermediate frequency low pass filter IFLPF are flat. Thus, the interference wave suppression ratio can be increased (see the dashed line in FIG. 5).

However, if an interference wave frequency is near the cutoff frequency (interference wave 1 in FIG. 6) and the AGC convergence power is set as in the case of the interference wave 2, the input power to the intermediate frequency low pass filter IFLPF exceeds the input referred saturation power characteristics. Thus, the interference wave suppression ratio is deteriorated significantly (see the solid line in FIG. 5).

Namely, in order to improve the interference wave suppression ratio of a receiver, the intermediate frequency low pass filter IFLPF needs to have steep attenuation characteristics and capability of the receiver to remove interference waves needs to be improved. However, if the active filter is allowed to have steep attenuation characteristics, since deterioration of the input referred saturation power characteristics becomes significant near the cutoff frequency, the AGC convergence power needs to be decreased, resulting in a decrease of the interference wave suppression ratio. Namely, there is a trade-off relationship between the AGC convergence power and the interference wave suppression ratio. Specifically, if the AGC convergence power is increased to improve the interference wave suppression ratio with respect to the interference wave 2, the interference wave suppression ratio with respect to the interference wave 1 is deteriorated. If the AGC convergence power is reduced to improve the interference wave suppression ratio with respect to the interference wave 1, the interference wave suppression ratio with respect to the interference wave 2 cannot be improved.

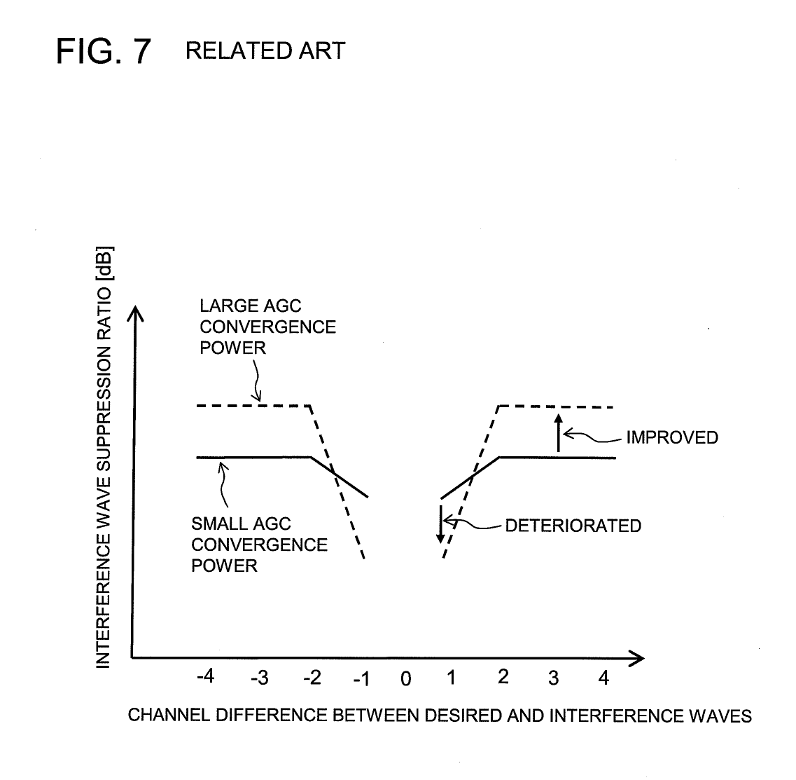

FIG. 7 illustrates a channel difference between desired and interference waves and a relationship between the AGC convergence power and the interference wave suppression ratio. As indicated by the dashed line with respect to the solid line in FIG. 7, when the channel difference between a desired wave and an interference wave is large, if the AGC convergence power is increased, the interference wave suppression ratio is improved. In contrast, however, when the channel difference between a desired wave and an interference wave is small, if the AGC convergence power is increased, the interference wave suppression ratio is deteriorated.

Next, outlines of exemplary embodiments of the present invention will be described. The drawings and reference characters referred to in the description of the following outlines of the exemplary embodiments are used to illustrate examples of the exemplary embodiments. Therefore, variations of the exemplary embodiments according to the present invention are not limited by the drawings and reference characters.

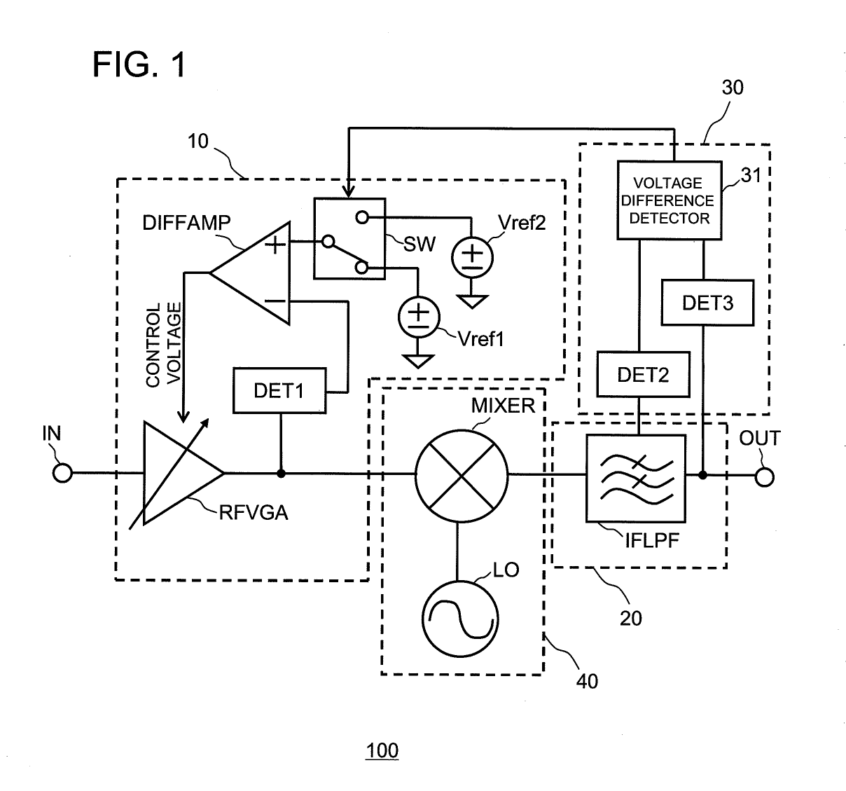

For example, as illustrated in FIGS. 1, 11, and 12, a receiver (100, 100A, 100B) according to an exemplary embodiment of the present invention includes: an automatic gain control (AGC) loop 10; a filter group (20, 20A) that is arranged downstream of the AGC loop 10 and that includes an active filter IFLPF; a power difference detector (30, 30A, 30B) that detects a power difference between intermediate and output nodes of the filter group (20, 20A) to detect presence of an interference wave that is different from a desired wave and that has a frequency near that of the desired wave; and a switch circuit SW that switches an operation to suppress a convergence power of the AGC loop 10 when the power difference detector (30, 30A, 30B) detects the interference wave. The AGC loop is a negative feedback loop including an amplifier (RFVGA, for example) that amplifies a received signal (signal inputted via the input terminal IN) based on the level thereof. The gain of the amplifier is automatically controlled so that an output power is converged to a certain power level.

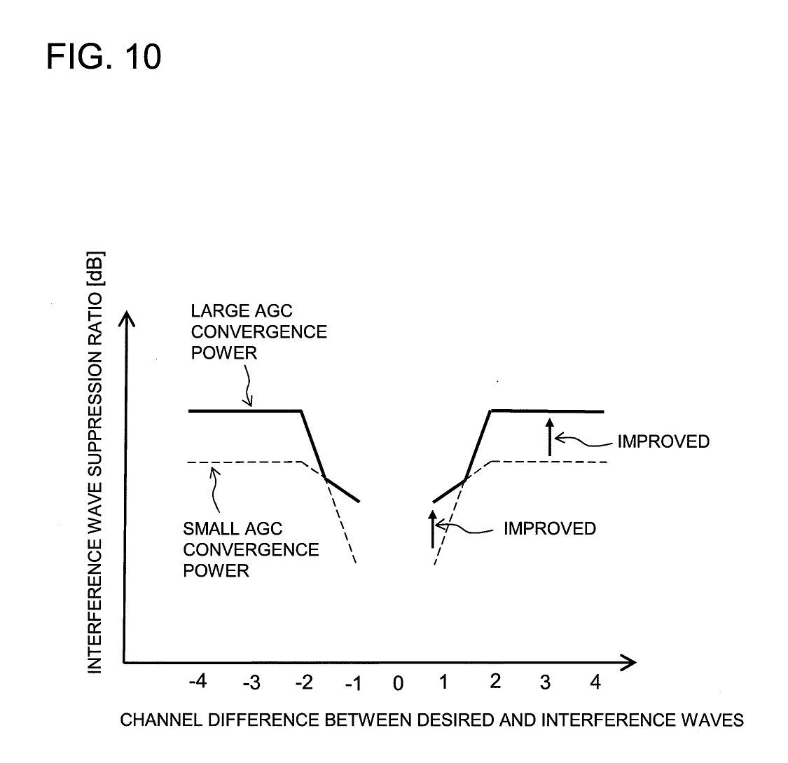

As illustrated by the solid line in FIG. 10, the AGC convergence power can be switched depending on presence/absence of the interference wave 1. Thus, by decreasing the AGC convergence power when the interference wave 1 is received and increasing the AGC convergence power when the interference wave 1 is not included, a good interference wave suppression ratio can be obtained in either case.

Further, for example, as illustrated in FIGS. 1, 11, and 12, the power difference detector (30, 30A, 30B) may include an intermediate node power detector DET2 that detects a power at the intermediate node to output a voltage based on the power; an output node power detector DET3 that detects a power at the output node to output a voltage based on the power; and a difference voltage detector (31 and 31A) that obtains a voltage difference between an output voltage from the intermediate node power detector DET2 and an output voltage from the output node power detector DET3 to generate a control signal switching the switch circuit SW.

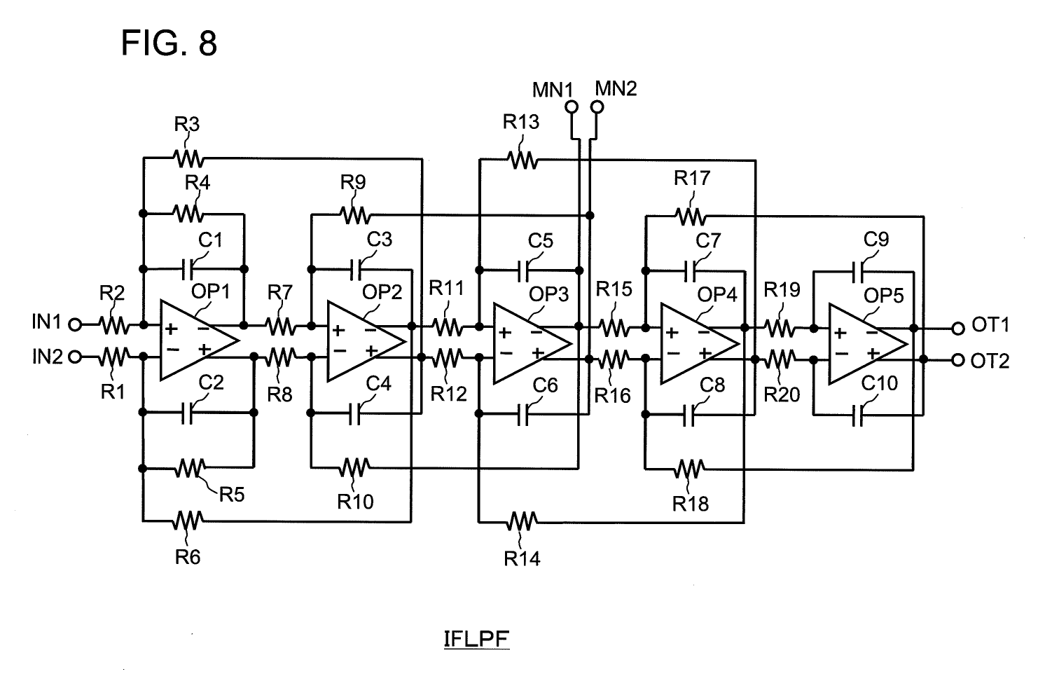

Further, the active filter IFLPF may include a plurality of cascaded stages. FIG. 8 illustrates a configuration example of the active filter IFLPF.

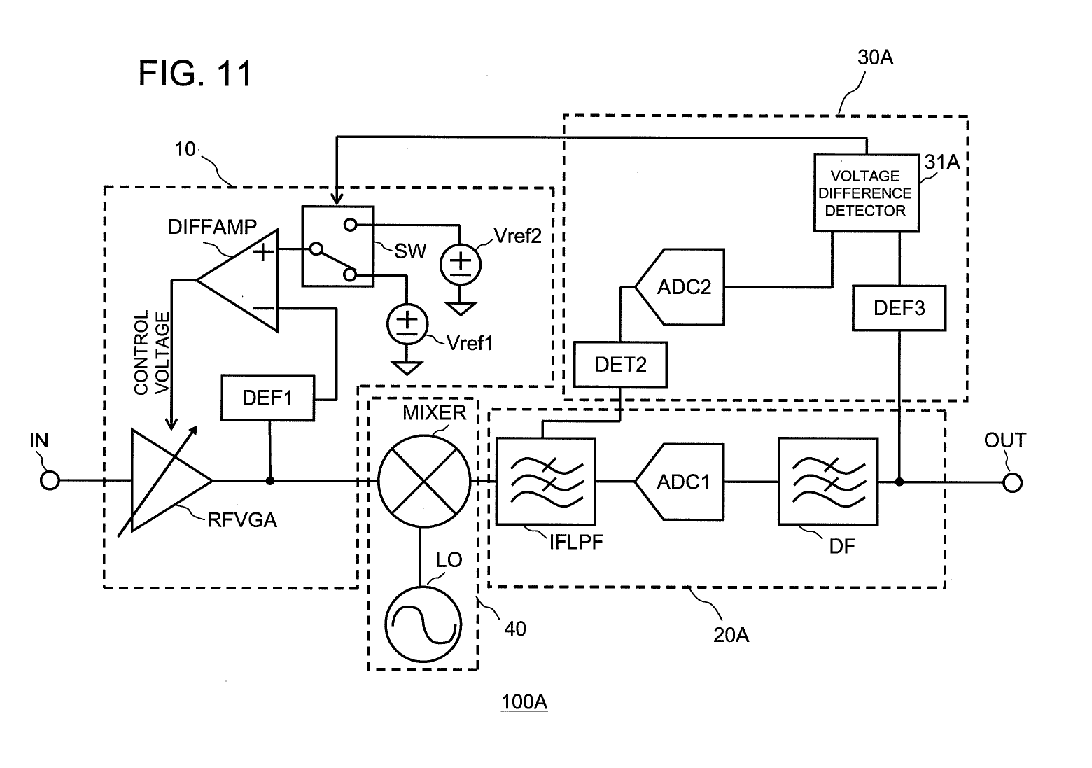

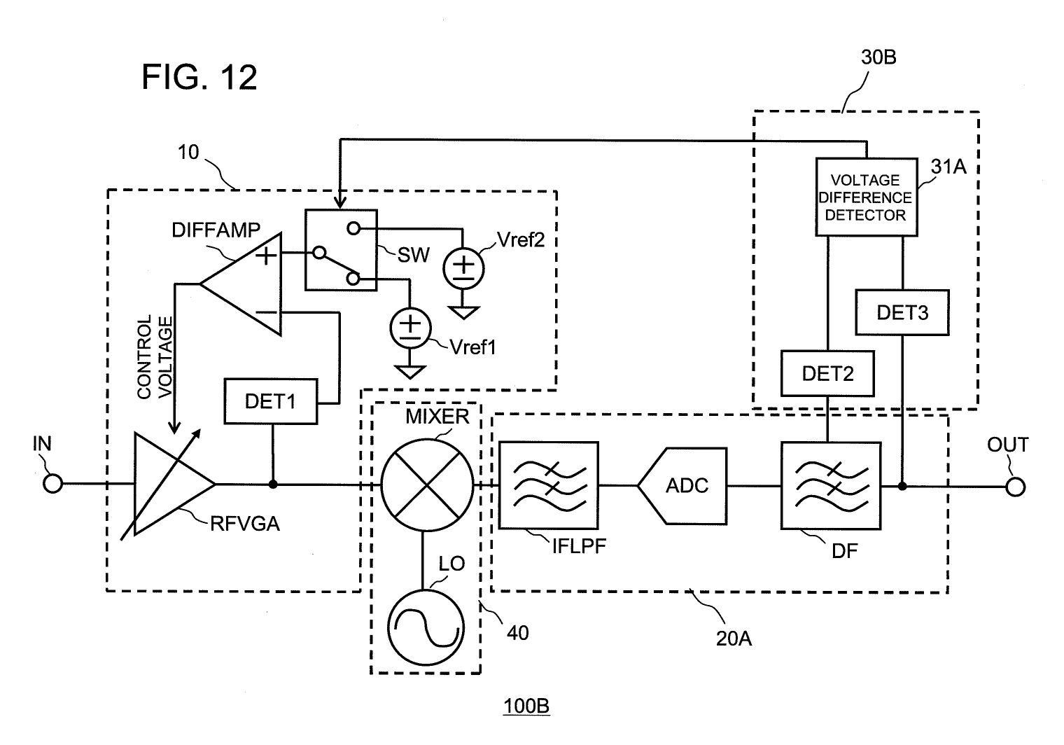

Further, for example, as illustrated in FIGS. 11 and 12, the filter group 20A may further include a digital filter DF arranged downstream of the active filter IFLPF. Furthermore, for example, as illustrated in FIGS. 1 and 8, the intermediate and output nodes may be intermediate and output nodes (MN1, MN2, OT1, OT2) of the active filter IFLPF.

Further, for example, as illustrated in FIG. 11, the intermediate node may be an intermediate node of the active filter IFLPF, and the output node may be an output node of the digital filter DF. Furthermore, for example, as illustrated in FIG. 12, the intermediate and output nodes may be intermediate and output nodes of the digital filter DF.

Further, for example, as illustrated in FIGS. 1, 8, 11, and 12, the active filter IFLPF may be an active low pass filter.

Further, for example, as illustrated in FIGS. 1, 11 and 12, the receiver may further include a frequency converter 40 that is arranged downstream of the AGC loop 10 to convert a received frequency to an intermediate frequency, and the intermediate frequency may be supplied to the filter group (20, 20A) as an input signal.

Further, a semiconductor device according to an exemplary embodiment of the present invention includes a semiconductor substrate and the receiver (100, 100A, 100B) is fabricated on the semiconductor substrate. The semiconductor substrate may be a n-type silicon substrate or a p-type silicon substrate.

The outlines of exemplary embodiments have thus been described. Next, specific examples of the present invention will be described in detail with reference to the drawings.

### EXAMPLE 1

FIG. 1 is a block diagram of an overall configuration of a receiver 100 according to example 1 of the present invention. The receiver 100 includes: an AGC loop 10 that amplifies a received signal inputted via an input terminal IN to a certain power level; a frequency converter 40 that converts the received signal amplified by the AGC loop 10 to an intermediate frequency; a filter group 20 that includes an intermediate frequency low pass filter IFLPF as an active filter to obtain a desired frequency signal from the intermediate frequency; and a power difference detector 30 that detects a power difference between intermediate and output nodes of the filter group to control a convergence power of the AGC loop 10.

The AGC loop 10 includes two reference voltages Vref1 and Vref2 as reference voltages. When an interference wave 1 is present in a frequency band where the input referred saturation power characteristics are low near a cutoff frequency of the intermediate frequency low pass filter IFLPF and near a desired wave, the reference voltage Vref1 is used as a reference to decrease a convergence power of the AGC loop 10 so that the intermediate frequency low pass filter IFLPF is not saturated. In contrast, when an interference wave 2 is present in a frequency band other than the frequency band where the input referred saturation power characteristics are low, the reference voltage Vref2 is used as a reference to increase a convergence power of the AGC loop 10 and obtain a high S/N ratio of the output from the intermediate frequency low pass filter IFLPF.

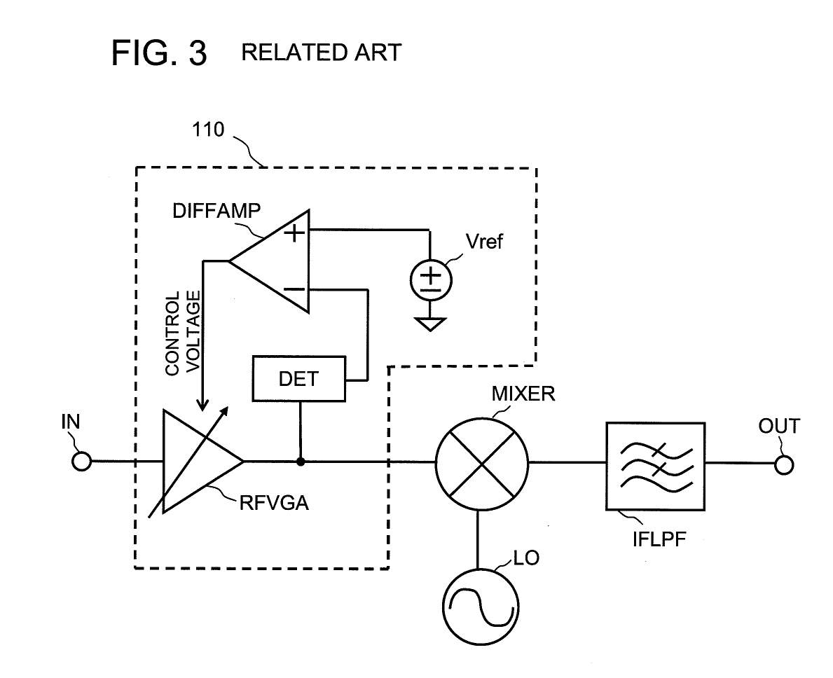

In addition, the AGC loop 10 includes a switching circuit SW that selects the reference voltage Vref1 or Vref2 used as a voltage to be compared by a differential amplifier DIFFAMP based on an output signal from the power difference detector 30. The switching circuit SW selects the reference voltage Vref1 when the interference wave 1 is present and selects the reference voltage Vref2 when the interference wave 1 is not present. When the reference voltage Vref1 is selected, the convergence power of the AGC loop 10 is decreased. When the reference voltage Vref2 is selected, the convergence power of the AGC loop 10 is increased. Other configurations of the AGC loop 10 are the same as those of the AGC loop 110 of FIG. 3 described above as a conventional technique. While the frequency converter 40 includes a local oscillator LO and a mixer circuit MIXER, configurations and functions thereof are identical to those of the local oscillator LO and the mixer circuit MIXER of FIG. 3 described as the conventional technique.

The filter group 20 includes an intermediate frequency low pass filter IFLPF as an active filter. FIG. 8 illustrates an internal circuit configuration of the intermediate frequency low pass filter IFLPF. As illustrated in FIG. 8, the intermediate frequency low pass filter IFLPF includes amplifiers OP1 to OP5 cascaded in five stages as well as resistors R1 to R20 and capacitors C1 to C10 forming the individual stages. The amplifier OP1 in the initial stage is connected to input nodes IN1 and IN2 of the intermediate frequency low pass filter IFLPF via the resistors R1 and R2, and output signals from the amplifier OP5 in the fifth stage are connected to output nodes OT1 and OT2. In addition, output signals from the amplifier OP3 in the third stage are connected to intermediate nodes MN1 and MN2. Even when the interference wave 1 and a desired wave are inputted to the input nodes IN1 and IN2 of the intermediate frequency low pass filter IFLPF, since these five amplifiers OP1 to OP5 have sufficient attenuation characteristics in total, filtering can be executed to output only the desired wave from the output nodes OT1 and OT2.

However, since an interference wave near a desired wave, such as the interference wave 1 in FIG. 6, is not yet completely removed at the intermediate nodes MN1 and MN2, signals including the desired wave and the interference wave 1 are outputted from the intermediate nodes MN1 and MN2 to which output signals from the third amplifier OP3 are connected. On the other hand, when the interference wave 2 is inputted to the input nodes IN1 and IN2, since the interference wave 2 can be completely removed at the intermediate nodes MN1 and MN2, only the desired wave can be outputted from the intermediate nodes MN1 and MN2.

In FIG. 1, the intermediate nodes MN1 and MN2 of the intermediate frequency low pass filter IFLPF are connected to an intermediate node power detector DET2 of the power difference detector 30. The output nodes OT1 and OT2 are connected to the output terminal OUT of the receiver 100 and to an output node power detector DET3 of the power difference detector 30. In FIG. 8, a pair of complementary signals is outputted from the intermediate nodes MN1 and MN2 and from the output nodes OT1 and OT2; however, in FIG. 1, the pair of complementary signals is simplified as a single signal.

The power difference detector 30 includes: the intermediate node power detector DET2 that detects a power at the intermediate node to output a voltage based on the power; the output node power detector DET3 that detects a power at the output node to output a voltage based on the power; and a difference voltage detector 31 that obtains a voltage difference between an output voltage from the intermediate node power detector DET2 and an output voltage from the output node power detector DET3 to generate a control signal switching the switching circuit SW.

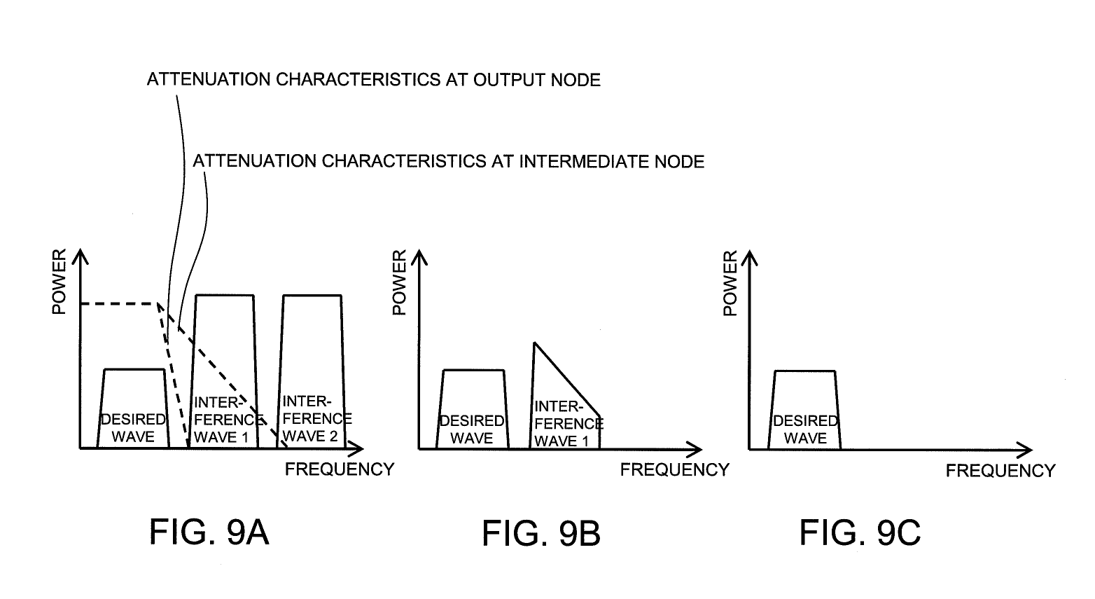

Next, an operation of the receiver 100 according to example 1 will be described with reference to FIGS. 9A to 9C. FIGS. 9A to 9C illustrate signal frequency and power levels at the input, intermediate, and output nodes of the intermediate frequency low pass filter IFLPF, respectively. FIG. 9A illustrates a signal observed at the input node of the intermediate frequency low pass filter IFLPF. Namely, the signal of FIG. 9A is obtained after a signal is inputted to the input terminal IN of the receiver 100, amplified by the AGC loop 10, converted by the frequency converter 40 to an intermediate frequency, and inputted to the intermediate frequency low pass filter IFLPF. This input signal includes the interference waves 1 and 2 in addition to a desired wave. Further, the interference waves 1 and 2 have a greater power than that of the desired wave. For reference, the attenuation characteristics at the intermediate and output nodes of the intermediate frequency low pass filter IFLPF are indicated by the dashed lines. It is seen that both the interference waves 1 and 2 are removed at the output node. It is also seen that, while the interference wave 2 is removed at the intermediate node, the interference wave 1 is not completely removed at the intermediate node.

FIG. 9B illustrates signal frequency and power levels observed at the intermediate node. At the intermediate node, while the interference wave 2 is already removed, part of the interference wave 1 is still present.

FIG. 9C illustrates signal frequency and power levels observed at the output node of the intermediate frequency low pass filter IFLPF. Since the interference wave 1 is completely removed at the output node, the signal outputted from the output node includes only the desired wave. Namely, at the intermediate node, while the interference wave 1 is still present, the interference wave 2 is completely removed. Further, at the output node, while both the interference waves 1 and 2 are completely removed, the desired wave is still present. Thus, by subtracting the power at the output node from the power at the intermediate node, whether or not the signal inputted to the intermediate frequency low pass filter IFLPF includes the interference wave 1 can be determined. In this way, the power difference detector 30 determines whether the input signal to the intermediate frequency low pass filter IFLPF includes the interference wave 1 based on the power at the intermediate node and the power at the output node of the intermediate frequency low pass filter.

If the signal inputted to the intermediate frequency low pass filter IFLPF includes the interference wave 1, the input referred saturation power characteristics of the intermediate frequency low pass filter IFLPF are decreased. Thus, the AGC loop 10 decreases an AGC loop convergence power to prevent saturation of the intermediate frequency low pass filter IFLPF.

On the other hand, if the signal inputted to the intermediate frequency low pass filter IFLPF does not include the interference wave 1, the input referred saturation power characteristics of the intermediate frequency low pass filter IFLPF are not decreased. Thus, the AGC loop 10 increases the AGC loop convergence power to increase an S/N ratio of the output signal from the receiver 100.

Consequently, as illustrated in FIG. 10, the AGC convergence power is changed depending on presence of the interference wave 1. Namely, the AGC convergence power can be changed, so that a maximum interference wave suppression ratio is obtained, whether the interference wave is the interference wave 1 or 2.

The above receiver 100 according to example 1 can be formed on a semiconductor substrate as a semiconductor integrated circuit.

### EXAMPLE 2

FIG. 11 is a block diagram of a receiver 100A according to example 2. The receiver 100A of FIG. 11 includes blocks having configurations and functions approximately identical to those of blocks of the receiver 100 of FIG. 1. Thus, like elements and functions are denoted by like reference numerals in FIGS. 1 and 11, and detailed description thereof will be omitted. The receiver 100A according to example 2 includes an AD converter ADC1 and a digital filter DF downstream of the intermediate frequency low pass filter IFLPF. According to example 2, the intermediate frequency low pass filter IFLPF as an active filter and the digital filter DF arranged downstream thereof form a filter group 20A. According to example 2, the digital filter DF, the output node power detector DET3, and a difference voltage detector 31A are formed by digital circuits.

Basic operations of the receiver according to example 2 are the same as those of the receiver 100 according to example 1. When a received signal inputted to the intermediate frequency low pass filter IFLPF includes the interference wave 1, an output voltage from the intermediate node power detector DET2 becomes greater than an output voltage from the output node power detector DET3. Thus, the difference voltage detector 31A outputs a high level, and the switching circuit SW selects the reference voltage Vref1. On the other hand, when the received signal inputted to the intermediate frequency low pass filter IFLPF does not include the interference wave 1, output voltages from the intermediate node power detector DET2 and the output node power detector DET3 are approximately(or substantially) equal to each other. Thus, the difference voltage detector 31A outputs a low level, and the switching circuit SW selects the reference voltage Vref2. Since the reference voltage Vref2 is set to be higher than the reference voltage Vref1, when the reference voltage Vref2 is selected, compared with the reference voltage Vref1, the AGC loop convergence power is increased and the S/N ratio is improved, whereby the interference wave suppression ratio can also be improved.

In addition, according to example 2, the digital filter DF also plays a part in removing the interference wave. However, since this digital filter DF is not an active filter, no deterioration in input referred saturation power characteristics is caused. In the filter group 20A, the intermediate frequency low pass filter IFLPF is the only block formed as an active filter.

According to example 1, the intermediate frequency low pass filter IFLPF, the intermediate node power detector DET2, and the output node power detector DET3 that detect presence of the interference wave 1 are all formed by analog circuits. Thus, when the receiver 100 is formed on a semiconductor substrate as an integrated circuit, variations in attenuation characteristics of the intermediate frequency low pass filter IFLPF may be caused during manufacture. In addition, variations in power-voltage conversion characteristics of the intermediate node power detector DET2 and the output node power detector DET3 may be caused. Such variations may change a power range for detection of the interference wave 1. Thus, each of the analog circuits may require strict characteristics to stably carry out its designed operation.

Contrastingly, according to example 2, among the blocks that detect presence of the interference wave 1, the output node power detector DET3 is digitized, and thus, an impact caused by the semiconductor manufacture variations can be reduced. Further, since a signal passes through the digital filter DF before inputted to the output node power detector DET3, power of a desired wave can be detected more accurately. Because of these differences, a power range for detection of the interference wave 1 is more stabilized compared with example 1. Thus, “improvement of the interference wave suppression ratio based on the interference wave frequency” can be realized more stably. Furthermore, since the output node power detector DET3 is digitalized, reduction of the layout area can be achieved. Depending on characteristics of the intermediate frequency low pass filter IFLPF, even when the digital filter DF is removed from the above configuration of example 2, similar operations and advantages can be realized.

### EXAMPLE 3

FIG. 12 is a block diagram of a receiver 100B according to example 3. According to example 3, in addition to the digital circuits according to example 2 of FIG. 11, the intermediate node power detector DET2 is also formed by a digital circuit. The intermediate node power detector DET2 is connected to the digital filter DF so that the power at the intermediate node of the digital filter DF is detected. In this way, the attenuation characteristics of the intermediate frequency low pass filter IFLPF can be set to be more gradual than those according to examples 1 and 2. Since the attenuation characteristics of the intermediate frequency low pass filter IFLPF are gradual, the interference wave 1 somewhat attenuated also appears in addition to a desired wave at the output from the intermediate frequency low pass filter IFLPF. Namely, information about the interference wave 1 is present at the input node of the digital filter DF. Thus, by detecting levels at the intermediate and output nodes of the digital filter DF with the intermediate node power detector DET2 and the output node power detector DET3, a power difference between the intermediate and output nodes of the digital filter DF based on presence/absence of the interference wave 1 can be detected. Therefore, the receiver 100B according to example 3 can function in the same way as those according to examples 1 and 2. Depending on characteristics of the digital filter DF, even when dedicated digital filters for detecting power at the intermediate and output nodes are added to the configuration of example 3, similar operations and advantages can be realized.

According to example 3, while the intermediate frequency low pass filter IFLPF is formed as an active filter, as described above, the attenuation characteristics can be set to be more gradual than those according to examples 1 and 2. Thus, since deterioration of the input referred saturation power characteristics near a cutoff frequency of the intermediate frequency low pass filter IFLPF is reduced, the AGC convergence power can be increased, the S/N ratio of the output from the IFPLF can be improved, and the overall interference wave suppression ratio of the receiver can be improved. The attenuation characteristics reduced by the intermediate frequency low pass filter IFLPF formed as an active filter can be compensated by the digital filter DF.

Further, since all the blocks used to detect presence of the interference wave 1 are digitized, when the receiver 100B is formed on a semiconductor substrate as a semiconductor integrated circuit, an impact caused by semiconductor manufacture variations can be reduced. As a result, a power range for detection of the interference wave 1 can be further stabilized. Additionally, by realizing the intermediate node power detector DET2 and the output node power detector DET3 with digital signal processing circuits, reduction of the layout area can be achieved.

In the above description of examples 1 to 3, the active filter is a low pass filter that cuts off an interference wave having a frequency higher than that of a desired wave. However, the present invention is also effective even when the active filter is a bandpass filter that passes only a certain frequency band or a high pass filter that cuts off signals having a frequency lower than that of a desired wave. Namely, the active filter of the present invention is not limited to a low pass filter.

Further, in examples 1 to 3, the receiver includes the frequency converter 40 upstream of the active filter, and the frequency converter 40 converts a frequency to an intermediate frequency and supplies the intermediate frequency to the active filter. However, depending on the frequency band of a desired wave or application of the receiver, such conversion to an intermediate frequency is not necessary. For example, an output signal from the AGC loop may be inputted directly to the active filter.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A receiver comprising:
an automatic gain control (AGC) loop;
a filter group that is arranged downstream of the AGC loop and that includes an active filter;
a power difference detector that detects a power difference between intermediate and output nodes of the filter group to detect presence of an interference wave that is different from a desired wave and that has a frequency near that of the desired wave; and
a switch circuit that switches an operation to suppress a convergence power of the AGC loop when the power difference detector detects the interference wave.

2. The receiver according to claim 1, wherein the power difference detector comprises:
an intermediate node power detector that detects a first power at the intermediate node to output a voltage based on the first power;
an output node power detector that detects a second power at the output node to output a voltage based on the second power; and
a difference voltage detector that obtains a difference voltage between an output voltage from the intermediate node power detector and an output voltage from the output node power detector to generate a control signal switching the switch circuit.

3. The receiver according to claim 1, wherein the active filter comprises a plurality of cascaded stages.

4. The receiver according to claim 1, wherein the filter group further comprises a digital filter arranged downstream of the active filter.

5. The receiver according to claim 3, wherein the intermediate and output nodes are intermediate and output nodes of the active filter.

6. The receiver according to claim 4, wherein the intermediate node is an intermediate node of the active filter, and the output node is an output node of the digital filter.

7. The receiver according to claim 4, wherein the intermediate and output nodes are intermediate and output nodes of the digital filter.

8. The receiver according to claim 1, wherein the active filter is an active low pass filter.

9. The receiver according to claim 1, further comprising a frequency converter that is arranged downstream of the AGC loop to convert a received frequency to an intermediate frequency, wherein the intermediate frequency is supplied to the filter group as an input signal.

10. The receiver according to claim 2, wherein the active filter comprises a plurality of cascaded stages.

11. The receiver according to claim 2, wherein the filter group further comprises a digital filter arranged downstream of the active filter.

12. The receiver according to claim 3, wherein the filter group further comprises a digital filter arranged downstream of the active filter.

13. The receiver according to claim 10, wherein the intermediate and output nodes are intermediate and output nodes of the active filter.

14. The receiver according to claim 11, wherein the intermediate node is an intermediate node of the active filter, and the output node is an output node of the digital filter.

15. The receiver according to claim 12, wherein the intermediate and output nodes are intermediate and output nodes of the digital filter.

16. A semiconductor device comprising:
a semiconductor substrate; and
a receiver fabricated on the semiconductor substrate,
wherein the receiver comprises:
an automatic gain control (AGC) loop;
a filter group that is arranged downstream of the AGC loop and that includes an active filter;
a power difference detector that detects a power difference between intermediate and output nodes of the filter group to detect presence of an interference wave that is different from a desired wave and that has a frequency near that of the desired wave; and
a switch circuit that switches an operation to suppress a convergence power of the AGC loop when the power difference detector detects the interference wave.

17. The semiconductor device according to claim 16, wherein the power difference detector comprises:
an intermediate node power detector that detects a first power at the intermediate node to output a voltage based on the first power;
an output node power detector that detects a second power at the output node to output a voltage based on the second power; and
a difference voltage detector that obtains a difference voltage between an output voltage from the intermediate node power detector and an output voltage from the output node power detector to generate a control signal switching the switch circuit.

18. The semiconductor device according to claim 16, wherein the active filter comprises a plurality of cascaded stages, and wherein the intermediate and output nodes are intermediate and output nodes of the active filter.

19. The semiconductor device according to claim 16, wherein the filter group further comprises a digital filter arranged downstream of the active filter, and wherein the intermediate node is an intermediate node of the active filter, and the output node is an output node of the digital filter.

20. The semiconductor device according to claim 16, wherein the filter group further comprises a digital filter arranged downstream of the active filter, and wherein the intermediate and output nodes are intermediate and output nodes of the digital filter.
